(19) United States
(12) Patent Application Publication
(10) Pub. No.: US 2020/0372226 A1
(43) Pub. Date: Nov. 26, 2020

(54) CONVERSATION CONTEXTUAL LEARNING-BASED AUTOMATIC TRANSLATION DEVICE AND METHOD

(71) Applicant: ELECTRONICS AND TELECOMMUNICATIONS RESEARCH INSTITUTE, Daejeon (KR)

(72) Inventor: Oh Woog KWON, Daejeon (KR)

(21) Appl. No.: 16/852,791

(22) Filed: Apr. 20, 2020

(30) Foreign Application Priority Data
May 22, 2019 (KR) 10-2019-0060202

(51) Int. Cl. G06F 40/58; G06N 3/08

(52) U.S. Cl. CPC G06F 40/58; G06N 3/08

(57) ABSTRACT

A conversation contextual learning-based automatic translation device includes a bidirectional conversation translation set collection unit configured to collect a bidirectional conversation translation set which is in a conversation form; an automatic translation knowledge learning unit configured to build first language-second language bidirectional conversation translation learning knowledge using a first language-second language bidirectional conversation translation set; and a translation unit configured to translate a first language, when received from a first-language user terminal, into a second language using the built first language-second language bidirectional conversation translation learning knowledge and second-language conversation context information provided via a conversation context manager.

### CROSS-REFERENCE TO RELATED APPLICATION

This application claims priority to and the benefit of Korean Patent Application No. 10-2019-0060202, filed on May 22, 2019, the disclosure of which is incorporated herein by reference in its entirety.

### BACKGROUND

### 1. Field of the Invention

The present disclosure relates to a conversation contextual learning-based automatic translation device and method, and more particularly, to a conversation contextual learning-based automatic translation device and method which are capable of improving interpretation and translation service quality by sharing information represented in the other party's language and facilitating communication with the other party.

### 2. Description of Related Art

High-quality automatic translation devices currently on the market use a statistical machine translation method and a neural machine translation method to learn translation information from a large number of translated bilingual sentences.

Generally, among such high-quality automatic translation devices, a device that translates one's native language into the other party's language and a translation device that translates the other party's language into the one's native language operate independently in a conversation with a foreigner.

However, the two independent translation devices which are high-quality automatic translation devices of the related art cannot refer to the other party's conversation which is very important in the context of a conversation.

For example, a Korean's conversation “ [symbol] [symbol] ” is translated into “I will nominate him for a club president.” through Korean-English automatic translation.

When the other party who fully understands the translation says in English “I don't nominate him for the president.”, this sentence may be translated into “ [symbol] [symbol] [symbol] ” through English-Korean automatic translation, because there is no information representing that the “president” mentioned by the other party corresponds to “ [symbol] ” and translation information of translated sentences is frequently used among translated sentences for learning.

Korean Patent No. 10-1694286 (Jan. 3, 2017), entitled “Device and Method for Providing Two-way Automatic Interpretation and Translation Service” and U.S. Pat. No. 9,058,322 (Jun. 16, 2015), entitled “Apparatus and Method for Providing Two-way Automatic Interpretation and Translation Service” disclose that conversation contexts including information regarding conversation with the other party and translation information thereof may be used when two independent translation devices provide translation and interpretation services bi-directionally.

However, the apparatuses and methods for providing two-way automatic interpretation and translation service of the related art are disadvantageous in that a method of using information regarding contexts of the other party's conversation cannot be provided in a translation method of learning a large number of bidirectional sentences for learning.

### SUMMARY OF THE INVENTION

To address the above problem of the related art, the present disclosure is directed to providing a conversation contextual learning-based automatic translation device applicable to a learning-based automatic translation device which uses the context and history information of the other party's conversation but does not overcome grammatical and semantic ambiguity by stages.

The present disclosure is also directed to providing a conversation contextual learning-based automatic translation device for learning the context of a conversation using information regarding a counterpart language and providing high-quality learning-based automatic translation using the learned context of the conversation.

Aspects of the present disclosure are not limited thereto and other aspects mentioned herein will be apparent to those of ordinary skill in the art from the following description.

According to one aspect of the present disclosure, a conversation contextual learning-based automatic translation device includes a bidirectional conversation translation set collection unit configured to collect a bidirectional conversation translation set which is in a conversation form; an automatic translation knowledge learning unit configured to build first language-second language bidirectional conversation translation learning knowledge using the bidirectional conversation translation set; and a translation unit configured to perform a translation into a counterpart language using the built first language-second language bidirectional conversation translation learning knowledge and context of a conversation in the counterpart language provided via a conversation context manager.

The translation unit may translate a first language, when received from a first-language user terminal, into a second language using the built first language-second language bidirectional conversation translation learning knowledge and second-language conversation context information provided from the conversation context manager, and translate the second language, when received from a second-language user terminal, into the first language using the built first language-second language bidirectional conversation translation learning knowledge and first-language conversation context information provided from the conversation context manager.

The automatic translation knowledge learning unit may include first language-second language automatic translation learning knowledge learned for automatic translation of a first-language original into a second-language translation, and second language-first language automatic translation learning knowledge learned for automatic translation of a second-language original into a first-language translation.

The automatic translation knowledge learning unit may include a first language-second language automatic translation learning unit configured to be trained by a neural network or statistics-based method to generate the second-language translation using the first-language original and second-language translation word information according to the context of the conversation which are aligned with each other by a learning language context information processor; and a second language-first language automatic translation learning unit configured to be trained by the neural network or statistics-based method to generate the first-language translation using the second-language original and first-language translation word information according to the context of the conversation which are aligned with each other by the learning language context information processor.

The translation unit may include a first language-second language translator; a second language-first language translator; and a conversation context manager configured to build context of the conversation by collecting sentences input from a first-language user and a second-language user during the conversation according to an order of the conversation, and provide the context of the conversation to the first language-second language translator and the second language-first language translator to support use of previous conversation sentences of a counterpart-language user as context.

The first language-second language translator may include a first language-second language translation context information processor configured to receive a first-language sentence input from a first-language user and previous n conversation sentences from a second-language user stored by the conversation context manager, and generate information indicating whether a translation word into which the first-language original is likely to be translated appears in second-language conversation context, the second-language conversation context including the previous n conversation sentences from the second-language user; and a first language-second language automatic translator configured to generate a second-language translation of the first-language original by the neural network or statistics-based method learned by the first language-second language automatic translation knowledge learning unit, based on the first-language original and the second-language translation word information according to the context of the conversation which are aligned by the first language-second language translation context information processor and the first language-second language automatic translation learning knowledge learned by the first language-second language automatic translation knowledge learning unit.

According to another aspect of the present disclosure, a conversation contextual learning-based automatic translation method includes collecting a bidirectional conversation translation set which is in a conversation form by a bidirectional conversation translation set collection unit; building, by an automatic translation knowledge learning unit, first language-second language bidirectional conversation translation learning knowledge using a first language-second language bidirectional conversation translation set; and translating, by a translation unit, a first language, when received from a first-language user terminal, into a second language using the built first language-second language bidirectional conversation translation learning knowledge and second-language conversation context information provided from a conversation context manager. The conversation contextual learning-based automatic translation method may further include translating, by the translation unit, the second language, when received from a second-language user terminal, into the first language using the built first language-second language bidirectional conversation translation learning knowledge and first-language conversation context information provided from the conversation context manager.

The bidirectional conversation translation set may be a set of conversations including a conversation in a first language and a second language and a translation of the conversation into a counterpart language. In the bidirectional conversation translation set, the start and end of each of the conversations are marked to differentiate between the conversations.

The first language-second language bidirectional conversation translation learning knowledge may include first language-second language automatic translation learning knowledge learned for automatic translation of a first-language original into a second-language translation, and second language-first language automatic translation learning knowledge learned for automatic translation of a second-language original into a first-language translation.

The translating of the first language into the second language using the second-language conversation context information may include building, by the conversation context manager, context of the conversation by collecting sentences input from a first-language user and a second-language user during the conversation according to an order of the conversation; providing, by the conversation context manager, the context of the conversation to a first language-second language translator and a second language-first language translator to use previous conversation sentences from a counterpart-language user as context; translating, by the first language-second language translator, the first language, when received from a first-language user terminal, into the second language using the built first language-second language bidirectional conversation translation learning knowledge and second-language conversation context information provided from the conversation context manager; and translating, by the second language-first language translator, the second language, when received from a second-language user terminal, into the first language using the built second language-first language bidirectional conversation translation learning knowledge and first-language conversation context information provided from the conversation context manager.

The translating of the second language into the first language using the first-language conversation context information may include building, by the conversation context manager, the context of the conversation by collecting sentences input from the first-language user and the second-language user during the conversation according to an order of the conversation; providing, by the conversation context manager, the context of the conversation to the second language-first language translator and the first language-second language translator to use previous conversation sentences from a counterpart-language user as context; translating, by the second language-first language translator, the second language, when received from a second-language user terminal, into the first language using the built second language-first language bidirectional conversation translation learning knowledge and first-language conversation context information provided from the conversation context manager; and translating, by the first language-second language translator, the first language, when received from a first-language user terminal, into the second language using the built first language-second language bidirectional conversation translation learning knowledge and second-language conversation context information provided from the conversation context manager.

The collecting of the bidirectional conversation translation set which is in a conversation form may include receiving, by a bidirectional conversation translation collector, a conversation, which includes an original of a conversation between a first-language user terminal and a second-language user terminal and a first language-second language conversation which is a translation of the original into a counterpart language, and building a first language-second language bidirectional conversation translation sentence set in which a range of the context of the conversation is indicated by marking the start and end of a bidirectional conversation consisting of the original and the translation of the original into the counterpart language; receiving, by a monolingual document translation converter, a monolingual document sentence and translation set consisting of a document written in the first language or the second language and sentences of the document translated into a counterpart language, and converting the monolingual document sentence and translation set into a first language-second language bidirectional conversation translation sentence set by representing the context of the conversation of the other party of each language with sentences (of an original or a translation) in the counterpart language matching previous sentences of the document; and receiving, by a translation sentence converter, a monolingual sentence and translation set consisting of only sentences written in the first language or the second language and a translation thereof and thus does not have previous context, and converting the monolingual sentence and translation set into a first language-second language bidirectional conversation translation sentence set by representing the context of each sentence of the conversation of the other party with sentences translated into a user's language.

The collecting of the bidirectional conversation translation set which is in a conversation form may include converting a second language-first language bidirectional conversation translation sentence set, in which a range of the context of a translation of the conversation from the second language into the first language is indicated, into a first language-second language bidirectional conversation translation sentence set by representing the context of the conversation of the other party of each language with sentences (of an original or a translation) in the counterpart language matching previous sentences of the document such that the first language-second language bidirectional conversation translation sentence set and the context of each sentence of the conversation of the other party may be translated into sentences in a user's language.

### BRIEF DESCRIPTION OF THE DRAWINGS

The above and other objects, features and advantages of the present disclosure will become more apparent to those of ordinary skill in the art by describing exemplary embodiments thereof in detail with reference to the accompanying drawings, in which:

FIG. 1 is a block diagram of a conversation contextual learning-based automatic translation device according to an embodiment of the present disclosure;

FIG. 2 is a block diagram illustrating a detailed configuration of an automatic translation knowledge learning unit of FIG. 1;

FIG. 3A is a block diagram illustrating a detailed configuration of a first language-second language automatic translation knowledge learning unit of FIG. 2;

FIG. 3B is a block diagram illustrating a detailed configuration of a second language-first language automatic translation knowledge learning unit of FIG. 2;

FIG. 4 is a block diagram illustrating a detailed configuration of a translation unit of FIG. 1;

FIG. 5A is a block diagram of a first language-second language translator of FIG. 4;

FIG. 5B is a block diagram of a second language-first language translator of FIG. 4;

FIG. 6 is a block diagram of a bidirectional conversation translation set collection unit of FIG. 1;

FIG. 7 is a flowchart of a conversation contextual learning-based automatic translation method according to an embodiment of the present disclosure;

FIG. 8 is a flowchart of a translation operation of FIG. 7; and

FIG. 9 is a flowchart of collecting bidirectional conversation translation sets which are in a conversation form of FIG. 7.

### DETAILED DESCRIPTION OF EXEMPLARY EMBODIMENTS

Advantages and features of the present disclosure and methods of achieving them will be apparent from embodiments described in detail, in conjunction with the accompanying drawings. However, the present disclosure is not limited to embodiments set forth herein and may be embodied in many different forms. The embodiments are merely provided so that this disclosure will be thorough and complete and will fully convey the scope of the disclosure to those of ordinary skill in the art. The present disclosure should be defined by the claims. The terms used herein are for the purpose of describing embodiments only and are not intended to be limiting of the present disclosure. As used herein, singular forms are intended to include plural forms unless the context clearly indicates otherwise. As used herein, the terms “comprise” and/or “comprising” specify the presence of stated components, steps, operations and/or elements but do not preclude the presence or addition of one or more other components, steps, operations and/or elements.

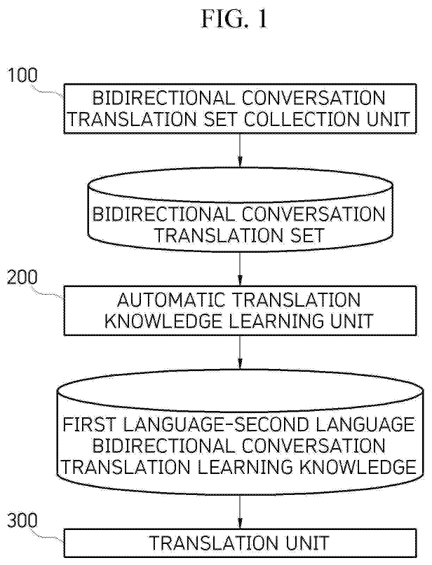

Hereinafter, embodiments of the present disclosure will be described in detail with reference to the accompanying drawings. FIG. 1 is a block diagram of a conversation contextual learning-based automatic translation device according to an embodiment of the present disclosure.

As illustrated in FIG. 1, the conversation contextual learning-based automatic translation device according to an embodiment of the present disclosure includes a bidirectional conversation translation set collection unit 100, an automatic translation knowledge learning unit 200, and a translation unit 300.

The bidirectional conversation translation set collection unit 100 collects a bidirectional conversation translation set which is in a conversation form. Here, the bidirectional conversation translation set is a set of conversations consisting of a conversation in a first language and a second language and a translation of a counterpart language. The bidirectional conversation translation set is a set of conversations and thus includes markers indicating the start and end of each of the conversations to distinguish between the conversations.

Here, the bidirectional conversation translation set collected according to an embodiment of the present disclosure may include a conversation of a first-language user and a translation thereof, but embodiments are not limited thereto and a one-way sentence translation set which includes only an original of one language and a translation of the original into a counterpart language may also be used.

The automatic translation knowledge learning unit 200 builds first language-second language bidirectional conversation translation learning knowledge using a first language-second language bidirectional conversation translation set. The first language-second language bidirectional conversation translation learning knowledge built in the present embodiment includes first language-second language automatic translation learning knowledge learned to automatically translate a first-language original into a second-language translation, and second language-first language automatic translation learning knowledge learned to automatically translate a second-language original into a first-language translation.

The translation unit 300 performs a translation into a counterpart language using the built first language-second language bidirectional conversation translation learning knowledge and the context of a conversation in the counterpart language provided via a conversation context manager.

The translation unit 300 may translate the first language, when received from a first-language user terminal, into the second language, using the built first language-second language bidirectional conversation translation learning knowledge and second-language conversation context information provided from the conversation context manager, and translate the second language, when received from a second-language user terminal, into the first language using the built second language-first language automatic translation learning knowledge and first-language conversation context information provided from the conversation context manager.

In an embodiment of the present disclosure, the other party's conversation context information may be stored by learning and translation may be performed using the learned conversation context information, so that translation may be performed using words and expressions in the context of a conversation with the other party who uses a foreign language and a partner of the conversation may grasp the other party's intension more easily.

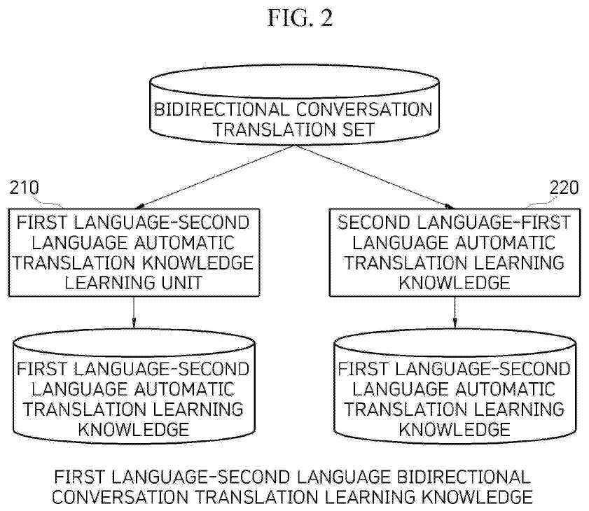

FIG. 2 is a block diagram illustrating a detailed configuration of an automatic translation knowledge learning unit of FIG. 1.

As illustrated in FIG. 2, the automatic translation knowledge learning unit 200 includes a first language-second language automatic translation knowledge learning unit 210 and a second language-first language automatic translation knowledge learning unit 220.

The first language-second language automatic translation knowledge learning unit 210 builds first language-second language bidirectional conversation translation learning knowledge using the bidirectional conversation translation set.

The second language-first language automatic translation knowledge learning unit 220 builds second language-first language bidirectional conversation translation learning knowledge using the bidirectional conversation translation set.

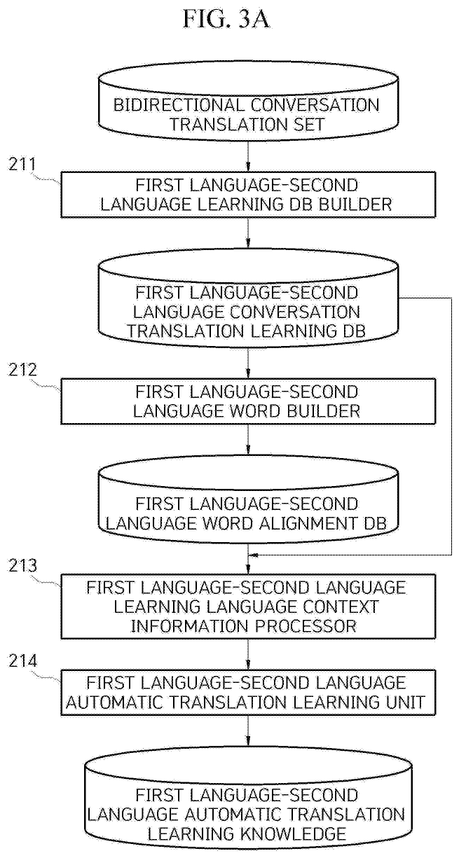

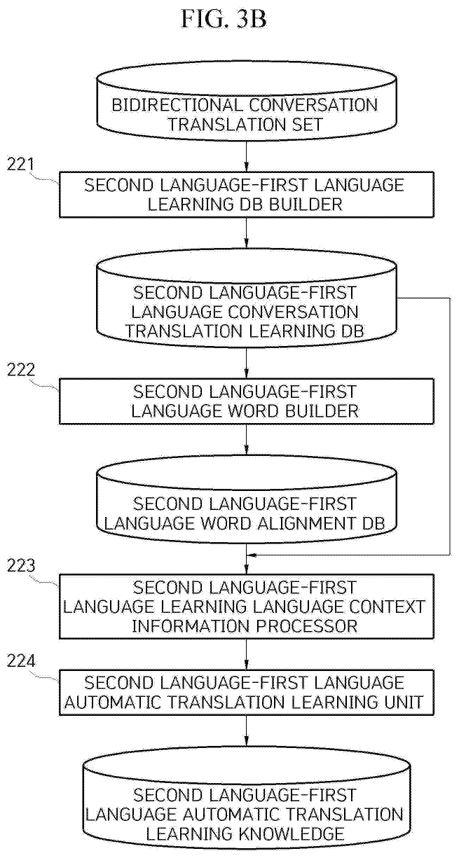

FIG. 3A is a block diagram illustrating a detailed configuration of the first language-second language automatic translation knowledge learning unit 210 of FIG. 2.

As illustrated in FIG. 3A, the first language-second language automatic translation knowledge learning unit 210 includes a first language-second language learning DB builder 211, a first language-second language word builder 212, a first language-second language learning language context information processor 213, and a first language-second language automatic translation learning unit 214.

The first language-second language learning DB builder 211 builds a first language-second language conversation translation learning DB for translation into the second language using a bidirectional conversation translation set based on the first language. Here, the first language-second language conversation translation learning DB includes triple data consisting of a first-language original, a second-language translation, and second-language conversation context. The first-language original is a first-language sentence among the first language-second language bidirectional conversation translation set, the second-language translation is a sentence accurately translated from the original, and second-language original sentences are extracted as the second-language conversation context prior to the first-language original from among the first language-second language bidirectional conversation translation set according to the context of a conversation. In case that the length of the conversation is long, the second-language conversation context may be limited to only previous n sentences.

The first language-second language word builder 212 builds a first language-second language word alignment DB by matching second-language words to a first-language word in the first language-second language conversation translation learning DB. The first language-second language word builder 212 builds the first language-second language word alignment DB, based on co-occurrence information or alignment information between original words of an original and translation words of a translation of the original from the first language-second language conversation translation learning DB. The first language-second language word alignment DB built as described above includes second-language translation words corresponding to a first-language word extracted by the first language-second language word builder 212 and weights to be assigned thereto.

Therefore, there are a plurality of second-language translation words corresponding to the first-language word, and the higher the weight assigned to a second-language translation word, the more frequently the second-language translation word may be used as a translation word.

When first language-to-second language automatic translation learning is performed, the first language-second language learning language context information processor 213 receives a first-language original and second-language conversation context sentences from the first language-second language conversation translation learning DB, and generates information indicating whether a translation word, into which the first-language original is likely to be translated, from among the first language-second language word alignment DB appears in context of a second-language conversation. It may be a simplest way to show a word, which is most likely to be translated as a word within the context of the conversation, after the original. A probability that an original will be translated into a word within the context of the conversation may be calculated by multiplying a weight of appearance of each of second-language translation words, for a word of the first-language original among the first language-second language word alignment DB, in context sentences of a conversation by a weight of each of the second-language translation words for the word of the first-language original among the first language-second language word alignment DB. The weight of appearance of each of the second-language translation words in the context of the conversation may be calculated by dividing the frequency of appearance of each of the second-language translation words by the frequency of appearance of entire words in the context of the conversation. In order to increase a weight of appearance in a second-language original close to the first-language original in terms of the context of a conversation and increase a weight of appearance of a second-language original distant from the first-language original, a frequency Count may be set to 1/n. Here, n represents the distance between the second-language original in which the second-language word appears and a current first-language original.

The first language-second language automatic translation learning unit 214 is trained by a neural network or statistics-based method to generate a second-language translation using a first-language original and second-language translation word information according to the context of a conversation which are aligned to each other by the first language-second language learning language context information processor 213.

For example, when the first language-second language bidirectional conversation translation learning DB includes a bidirectional conversation in which a Korean user spoke, “ [symbol] [symbol] ” and thereafter an English user spoke, “I don't nominate him for the president.”, the words that the Korean user spoke and a translation thereof may be built as a second language-first language learning DB and the words that the English user spoke and a translation thereof may be built as a first language-second language learning DB.

FIG. 3B is a block diagram illustrating a detailed configuration of the second language-first language automatic translation knowledge learning unit 220 of FIG. 2.

As illustrated in FIG. 3B, the second language-first language automatic translation knowledge learning unit 220 includes a second language-first language learning DB builder 221, a second language-first language word builder 222, a second language-first language learning language context information processor 223, and a second language-first language automatic translation learning unit 224.

The second language-first language learning DB builder 221 builds a second language-first language conversation translation learning DB for translation into the first language using a bidirectional conversation translation set on the basis of the second language.

The second language-first language word builder 222 builds a second language-first language word alignment DB by matching first-language words for a second-language word in the second language-first language conversation translation learning DB.

For learning an automatic translation from the second language into the first language, the second language-first language learning language context information processor 223 receives a second-language original and sentences according to the context of a first-language conversation from the second language-first language conversation translation learning DB, and generates information regarding appearance of a translation word, into which the second-language original is likely to be translated, in the context of a first-language conversation from among the second language-first language word alignment DB.

The second language-first language automatic translation learning unit 224 is trained by a neural network or statistics-based method to generate a first-language translation using a second-language original and first-language translation word information according to the context of a conversation which are aligned to each other by the second language-first language learning language context information processor 223.

As described above, the second language-first language automatic translation knowledge learning unit of FIG. 2 is different from the first language-second language automatic translation knowledge learning unit in terms of languages but is the same as the first language-second language automatic translation knowledge learning unit in terms of functions of the components thereof.

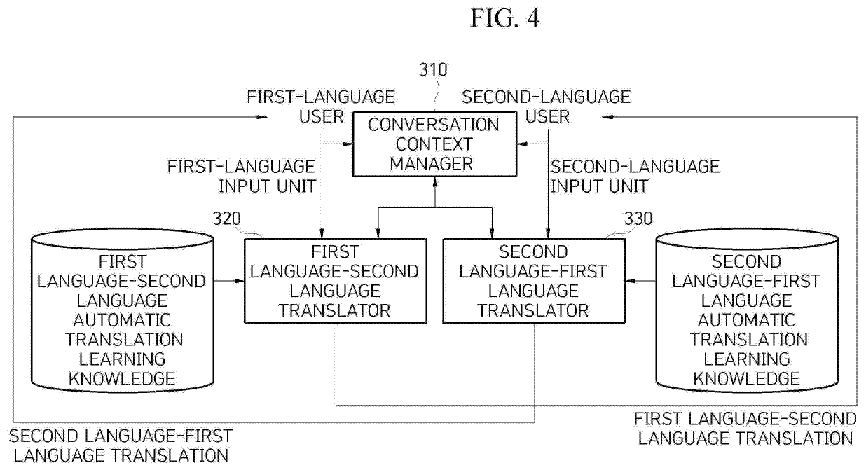

FIG. 4 is a block diagram illustrating a detailed configuration of the translation unit 300 of FIG. 1.

As illustrated in FIG. 4, the translation unit 300 includes a conversation context manager 310, a first language-second language translator 320, and a second language-first language translator 330.

The conversation context manager 310 constructs the context of a conversation by collecting sentences input from users who communicate with each other via a first-language user terminal and a second-language user terminal according to an order of the conversation, and provides the context of the conversation to the first language-second language translator 320 and the second language-first language translator 330 so as to use previous conversation sentences of a counterpart-language user as a context.

Here, the first language-second language translator 320 and the second language-first language translator 330 are different from each other only in terms of a language into which a translation is made but are the same in a specific translation method.

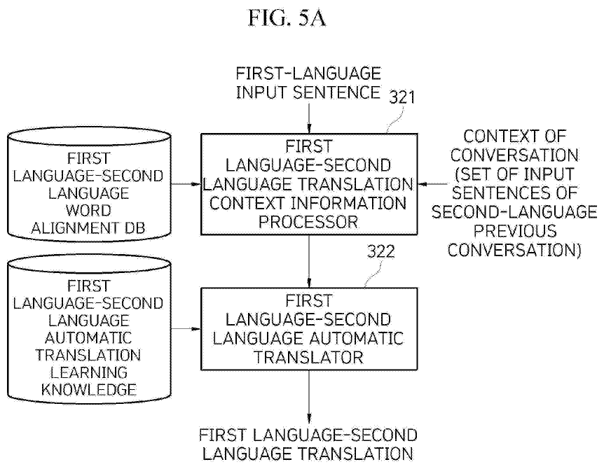

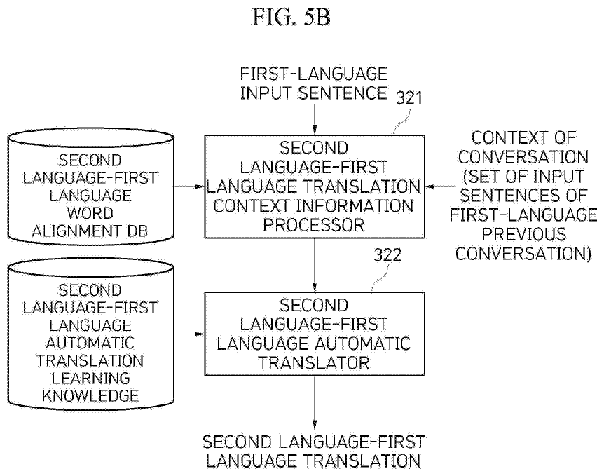

FIG. 5A is a block diagram of the first language-second language translator 320 of FIG. 4.

As illustrated in FIG. 5A, the first language-second language translator 320 includes a first language-second language translation context information processor 321 and a first language-second language automatic translator 322.

The first language-second language translation context information processor 321 receives a first-language input sentence input from a first-language user and previous n conversation sentences of a second-language user stored in the conversation context manager 310, and generates information indicating whether a translation word, into which a first-language original is likely to be translated, appears in the context of a second-language conversation (the previous n conversation sentences of the second-language user).

The first language-second language automatic translator 322 generates a second-language translation of a first-language original by a neural network or statistics-based method learned by the first language-second language automatic translation knowledge learning unit 210, based on information regarding a first-language original and a second language translation word according to the context of a conversation aligned by the first language-second language translation context information processor 321 and first language-second language automatic translation learning knowledge learned by the first language-second language automatic translation knowledge learning unit 210. For example, a Korean-language user spoke, “ [symbol] [symbol] [symbol] ” and thereafter an English-language user may translate it into “I don't nominate him for the president.”

In this case, the first language-second language translation context information processor 321 may receive “I don't nominate him for the president.” as a first-language original and “ [symbol] [symbol] ” as the context of a second-language conversation from the conversation context manager 310, and generate “I+ [symbol] don't+@ nominate+ [symbol] him+ [symbol] for+@ the+@ president+ [symbol] . +@ sent+ [symbol] ” as first-language original+second-language contextual information,

When well learned in the learning process as intended in the present disclosure, “president+@” will be translated into “ [symbol] ” and “president+ [symbol] ” would be translated as “ [symbol] ”.

When the above-described “sent + [symbol] ” which is information regarding an ending of a word is frequently used for translation of a declarative sentence in English into a Korean sentence according to a conversational context, the whole sentence, “I don't nominate him for the president.” may be translated into “ [symbol] [symbol] ” rather than “ [symbol] [symbol] .”

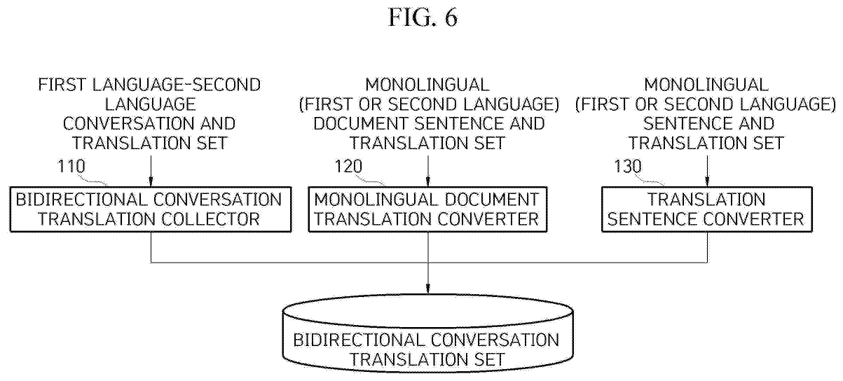

As illustrated in FIG. 6, the bidirectional conversation translation set collection unit 100 collects a first language-second language bidirectional conversation translation set, which includes sentences of a conversation between a first-language user terminal and a second-language user terminal and a translation of each-language original into a counterpart language and in which the start and end of the conversation are marked.

The bidirectional conversation translation set collection unit 100 includes a bidirectional conversation translation collector 110, a monolingual document translation converter 120, and a translation sentence converter 130.

The bidirectional conversation translation collector 110 receives a conversation, including an original of a conversation between a first-language user terminal and a second-language user terminal and a first language-second language conversation which is a translation of the original into a counterpart language, and builds a first language-second language bidirectional conversation translation sentence set in which a range of the context of the conversation is indicated by marking the start and end of a bidirectional conversation consisting of the original and the translation of the original into the counterpart language.

The monolingual document translation converter 120 receives a monolingual document sentence and translation set consisting of a monolingual document written in the first language or the second language and sentences of a translation of the document into a counterpart language, and converts it into a first language-second language bidirectional conversation translation sentence set by representing the context of the other party's conversation of each of the languages with sentences of the counterpart language (an original or a translation) matching previous sentences of the document.

The translation sentence converter 130 receives a monolingual sentence and translation set which consists of a sentence written in only the first language or the second language and a translation thereof and thus does not have a previous context, and converts it into a first language-second language bidirectional conversation translation sentence set by representing the context of each sentence in the other party's conversation with a sentence translated into a user's language.

The monolingual document translation converter 120 and the translation sentence converter 130 of the bidirectional conversation translation set collection unit 100 are used to solve problem of insufficient learning set when the amount of a collected bidirectional conversation translation set consisting of a first language-second language conversation and translations thereof is not sufficient for learning.

FIG. 5B is a block diagram of the second language-first language translator 330 of FIG. 4. As illustrated in FIG. 5B, the second language-first language translator 330 includes a second language-first language translation context information processor 331 and a second language-first language automatic translator 332.

The second language-first language translation context information processor 331 receives a second-language input sentence input from a second-language user and previous n conversation sentences of a first-language user stored in the conversation context manager 310, and generates information indicating whether a translation word, into which a second-language original is likely to be translated, appears in the context of a first-language conversation (the previous n conversation sentences of the first-language user).

The second language-first language automatic translator 332 generates a first-language translation of a second-language original by a neural network or statistics-based method learned by the second language-first language automatic translation knowledge learning unit 220, based on a second-language original and first-language translation word information according to the context of a conversation aligned by the second language-first language translation context information processor 331 and second language-first language automatic translation learning knowledge learned by the second language-first language automatic translation knowledge learning unit 220.

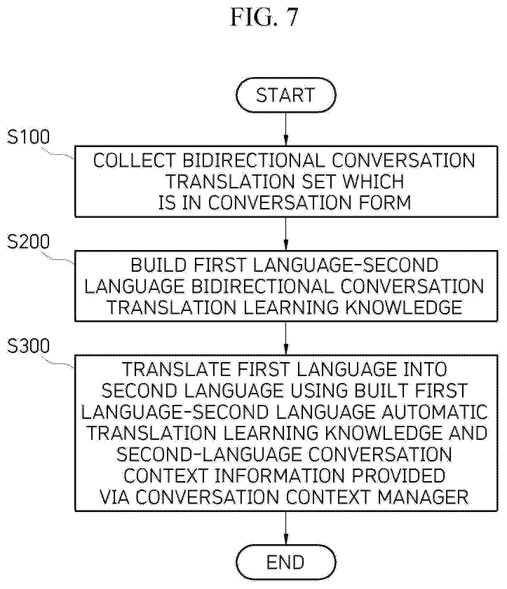

FIG. 7 is a flowchart of a conversation contextual learning-based automatic translation method according to an embodiment of the present disclosure.

A conversation contextual learning-based automatic translation method according to an embodiment of the present disclosure will be described with reference to FIG. 7 below.

The conversation contextual learning-based automatic translation method may be performed by components of the conversation contextual learning-based automatic translation device.

First, a bidirectional conversation translation set which is in a conversation form is collected by the bidirectional conversation translation set collection unit 100 (S100). Here, the bidirectional conversation translation set is a set of conversations consisting of a conversation in a first language and a second language and a translation of the conversation into a counterpart language. The bidirectional conversation translation set is a set of conversations and thus includes markers indicating the start and end of each of the conversations to distinguish between the conversations. The bidirectional conversation translation set collected according to an embodiment of the present disclosure may include a conversation between a first-language user terminal and a second-language user terminal and a translation thereof, but embodiments are not limited thereto and a one-way sentence translation set which includes only an original and a translation of the original into a counterpart language may also be used.

Next, the automatic translation knowledge learning unit 200 builds first language-second language bidirectional conversation translation learning knowledge using a first language-second language bidirectional conversation translation set (S200). The first language-second language bidirectional conversation translation learning knowledge built in the present embodiment includes first language-second language automatic translation learning knowledge learned to automatically translate a first-language original into a second-language translation, and second language-first language automatic translation learning knowledge learned to automatically translate a second-language original into a first-language translation.

As described above, the building of the first language-second language bidirectional conversation translation learning knowledge (S200) includes building a first language-second language conversation translation learning DB for translation of the first language into the second language using the first language-second language learning DB builder 211 of the automatic translation knowledge learning unit 200. Here, the first language-second language conversation translation learning DB includes triple data consisting of a first-language original, a second-language translation, and second-language conversation context. The first language original is a first-language sentence among the first language-second language bidirectional conversation translation set, and the second-language translation is a sentence into which the original is translated accurately. Here, second-language original sentences preceding the first-language original are extracted as the second-language conversation context from among the first language-second language bidirectional conversation translation set. In case that the length of the conversation is long, the second-language conversation context may be limited to only previous n sentences.

Thereafter, the first language-second language automatic translation learning unit 214 is trained by a neural network or statistics-based method to generate a second-language translation using information regarding a first-language original and a second-language translation word according to the context of a conversation aligned to each other by the first language-second language learning language context information processor 213. For example, when the first language-second language bidirectional conversation translation learning DB includes a bidirectional conversation in which a Korean user spoke, “ [symbol] [symbol] .” and thereafter an English user spoke, “I don't nominate him for the president.”, the words that the Korean user spoke and a translation thereof may be built as a second language-first language learning DB and the words that the English user spoke and a translation thereof may be built as a first language-second language learning DB. In this case, triple data is stored in the first language-second language learning DB, the triple data including “I don't nominate him for the president.” as a first-language original, “ [symbol] [symbol] .” as a second-language translation, and “ [symbol] [symbol] [symbol] .” as second language conversation context. In this case, the conversation context consists of only one sentence.

In addition, the building of the first language-second language bidirectional conversation translation learning knowledge (S200) may include building a second language-first language conversation translation learning DB for translation of the second language into the first language using the second language-first language learning DB builder 221 of the automatic translation knowledge learning unit 200.

Next, the second language-first language automatic translation learning unit 224 is trained by a neural network or statistics-based method to generate a first-language translation using information regarding a second-language original and a first-language translation word according to the context of a conversation aligned to each other by the second language-first language learning language context information processor 223.

Thereafter, when the first language is input from a first-language user terminal, the translation unit 300 translates the first language into the second language using the built first language-second language automatic translation learning knowledge and second-language conversation context information provided from a conversation context manager (not shown) (S300). When the second language is input from a second-language user terminal, the translation unit 300 translates the second language into the first language using the built second language-first language automatic translation learning knowledge and first-language conversation context information provided from the conversation context manager.

In an embodiment of the present disclosure, the other party's conversation context information may be stored by learning and translation may be performed using the learned conversation context information, so that translation may be performed using words and expressions in the context of a conversation with the other party who uses a foreign language and a partner of the conversation may grasp the other party's intension more easily.

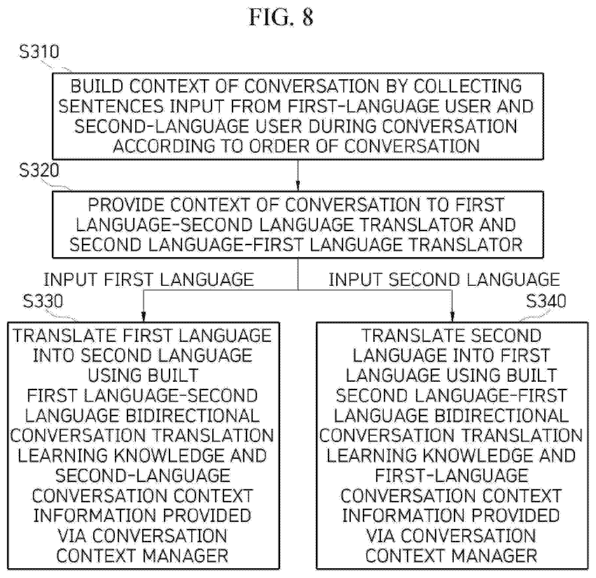

The translating of the input first language into the second language using second-language conversation context information according to an embodiment of the present disclosure (S300) will be described with reference to FIG. 8 below.

First, the conversation context manager 310 builds the context of a conversation by collecting sentences input from a first-language user and a second-language user during the conversation according to an order of the conversation (S310). Next, the conversation context manager 310 provides the context of the conversation to the first language-second language translator 320 and the second language-first language translator 330 to use previous conversation sentences of the other party as context (S320).

Next, when the first language is input from the first-language user terminal, the first language-second language translator 320 translates the first language into the second language using the built first language-second language bidirectional conversation translation learning knowledge and the second-language conversation context information provided from the conversation context manager 310 (S330).

When the second language is input from the second-language user terminal, the second language-first language translator 330 translates the second language into the first language using the built second language-first language bidirectional conversation translation learning knowledge and the first-language conversation context information provided from the conversation context manager 310 (S340).

In an embodiment of the present disclosure, the other party's conversation context information may be stored by learning and translation may be performed using the learned conversation context information, so that the translation may be performed using words and expressions in the context of a conversation with the other party who uses a foreign language and a partner of the conversation may grasp the other party's intension more easily.

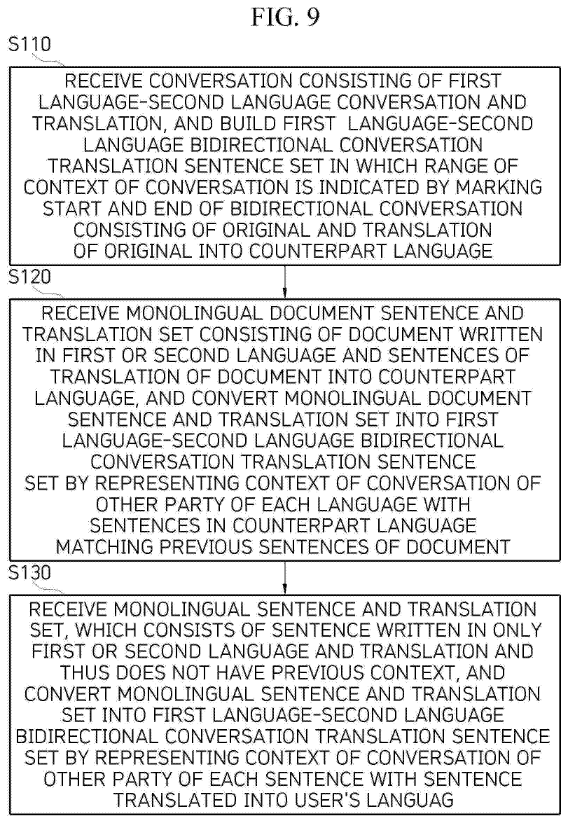

FIG. 9 is a flowchart for explaining the collecting of the bidirectional conversation translation set (S100) which is in a conversation form according to an embodiment of the present disclosure.

As illustrated in FIG. 9, the bidirectional conversation translation collector 110 receives a conversation, including an original of a conversation between a first-language user terminal and a second-language user terminal and a first language-second language conversation which is a translation of the original into a counterpart language, and builds a first language-second language bidirectional conversation translation sentence set in which a range of the context of the conversation is indicated by marking the start and end of a bidirectional conversation consisting of the original and the translation of the original into the counterpart language (S110).

The monolingual document translation converter 120 receives a monolingual document sentence and translation set consisting of a monolingual document written in the first language or the second language and sentences of a translation of the document into a counterpart language, and converts it into a first language-second language bidirectional conversation translation sentence set by representing the context of the other party's conversation of each of the languages with sentences of the counterpart language (an original or a translation) matching previous sentences of the document (S120).

The translation sentence converter 130 receives a monolingual sentence and translation set which consists of a sentence written in only the first language or the second language and a translation thereof and thus does not have a previous context, and converts it into a first language-second language bidirectional conversation translation sentence set by representing the context of each sentence in the other party's conversation with a sentence translated into a user's language (S130).

In an embodiment of the present disclosure, the other party's conversation context information may be stored by learning and translation may be performed using the learned conversation context information, so that translation may be performed using words and expressions in the context of a conversation with the other party who uses a foreign language and a partner of the conversation may grasp the other party's intension more easily.

While the configurations of the present disclosure have been described above in detail with reference to the accompanying drawings, the configurations are merely examples and various modifications and changes may be made therein within the scope of the present disclosure by those of ordinary skill in the technical field to which the present disclosure pertains. Therefore, the scope of the present disclosure is not limited to the aforementioned embodiments and should be defined by the following claims.

The components described in the example embodiments may be implemented by hardware components including, for example, at least one digital signal processor (DSP), a processor, a controller, an application-specific integrated circuit (ASIC), a programmable logic element, such as an FPGA, other electronic devices, or combinations thereof.

At least some of the functions or the processes described in the example embodiments may be implemented by software, and the software may be recorded on a recording medium.

The components, the functions, and the processes described in the example embodiments may be implemented by a combination of hardware and software.

The method according to example embodiments may be embodied as a program that is executable by a computer, and may be implemented as various recording media such as a magnetic storage medium, an optical reading medium, and a digital storage medium.

Various techniques described herein may be implemented as digital electronic circuitry, or as computer hardware, firmware, software, or combinations thereof. The techniques may be implemented as a computer program product, i.e., a computer program tangibly embodied in an information carrier, e.g., in a machine-readable storage device (for example, a computer-readable medium) or in a propagated signal for processing by, or to control an operation of a data processing apparatus, e.g., a programmable processor, a computer, or multiple computers.

A computer program(s) may be written in any form of a programming language, including compiled or interpreted languages and may be deployed in any form including a stand-alone program or a module, a component, a subroutine, or other units suitable for use in a computing environment.

A computer program may be deployed to be executed on one computer or on multiple computers at one site or distributed across multiple sites and interconnected by a communication network.

Processors suitable for execution of a computer program include, by way of example, both general and special purpose microprocessors, and any one or more processors of any kind of digital computer. Generally, a processor will receive instructions and data from a read-only memory or a random access memory or both. Elements of a computer may include at least one processor to execute instructions and one or more memory devices to store instructions and data. Generally, a computer will also include or be coupled to receive data from, transfer data to, or perform both on one or more mass storage devices to store data, e.g., magnetic, magneto-optical disks, or optical disks.

Examples of information carriers suitable for embodying computer program instructions and data include semiconductor memory devices, for example, magnetic media such as a hard disk, a floppy disk, and a magnetic tape, optical media such as a compact disk read only memory (CD-ROM), a digital video disk (DVD), etc. and magneto-optical media such as a floptical disk, and a read only memory (ROM), a random access memory (RAM), a flash memory, an erasable programmable ROM (EPROM), and an electrically erasable programmable ROM (EEPROM) and any other known computer readable medium.

A processor and a memory may be supplemented by, or integrated into, a special purpose logic circuit.

The processor may run an operating system (OS) and one or more software applications that run on the OS. The processor device also may access, store, manipulate, process, and create data in response to execution of the software. For purpose of simplicity, the description of a processor device is used as singular; however, one skilled in the art will be appreciated that a processor device may include multiple processing elements and/or multiple types of processing elements. For example, a processor device may include multiple processors or a processor and a controller. In addition, different processing configurations are possible, such as parallel processors.

Also, non-transitory computer-readable media may be any available media that may be accessed by a computer, and may include both computer storage media and transmission media.

The present specification includes details of a number of specific implements, but it should be understood that the details do not limit any invention or what is claimable in the specification but rather describe features of the specific example embodiment. Features described in the specification in the context of individual example embodiments may be implemented as a combination in a single example embodiment. In contrast, various features described in the specification in the context of a single example embodiment may be implemented in multiple example embodiments individually or in an appropriate sub-combination. Furthermore, the features may operate in a specific combination and may be initially described as claimed in the combination, but one or more features may be excluded from the claimed combination in some cases, and the claimed combination may be changed into a sub-combination or a modification of a sub-combination.

Similarly, even though operations are described in a specific order on the drawings, it should not be understood as the operations needing to be performed in the specific order or in sequence to obtain desired results or as all the operations needing to be performed. In a specific case, multitasking and parallel processing may be advantageous.

In addition, it should not be understood as requiring a separation of various apparatus components in the above described example embodiments in all example embodiments, and it should be understood that the above-described program components and apparatuses may be incorporated into a single software product or may be packaged in multiple software products.

It should be understood that the example embodiments disclosed herein are merely illustrative and are not intended to limit the scope of the invention. It will be apparent to one of ordinary skill in the art that various modifications of the example embodiments may be made without departing from the spirit and scope of the claims and their equivalents.

What is claimed is:

1. A conversation contextual learning-based automatic translation device comprising:
a bidirectional conversation translation set collection unit configured to collect a bidirectional conversation translation set which is in a conversation form;
an automatic translation knowledge learning unit configured to build first language-second language bidirectional conversation translation learning knowledge using the bidirectional conversation translation set; and
a translation unit configured to perform a translation into a counterpart language using the built first language-second language bidirectional conversation translation learning knowledge and context of a conversation in the counterpart language provided via a conversation context manager.

2. The conversation contextual learning-based automatic translation device of claim 1, wherein the translation unit translates a first language, when received from a first-language user terminal, into a second language using the built first language-second language bidirectional conversation translation learning knowledge and second-language conversation context information provided from the conversation context manager, and translates the second language, when received from a second-language user terminal, into the first language using the built first language-second language bidirectional conversation translation learning knowledge and first-language conversation context information provided from the conversation context manager.

3. The conversation contextual learning-based automatic translation device of claim 1, wherein the automatic translation knowledge learning unit comprises first language-second language automatic translation learning knowledge learned for automatic translation of a first-language original into a second-language translation, and second language-first language automatic translation learning knowledge learned for automatic translation of a second-language original into a first-language translation.

4. The conversation contextual learning-based automatic translation device of claim 3, wherein the automatic translation knowledge learning unit comprises:
a first language-second language automatic translation learning unit configured to be trained by a neural network or statistics-based method to generate the second-language translation using the first-language original and second-language translation word information according to the context of the conversation which are aligned with each other by a learning language context information processor; and
a second language-first language automatic translation learning unit configured to be trained by the neural network or statistics-based method to generate the first-language translation using the second-language original and first-language translation word information according to the context of the conversation which are aligned with each other by the learning language context information processor.

5. The conversation contextual learning-based automatic translation device of claim 1, wherein the translation unit comprises:
a first language-second language translator;
a second language-first language translator; and
a conversation context manager configured to build context of the conversation by collecting sentences input from a first-language user and a second-language user during the conversation according to an order of the conversation, and provide the context of the conversation to the first language-second language translator and the second language-first language translator to support use of previous conversation sentences of a counterpart-language user as context.

6. The conversation contextual learning-based automatic translation device of claim 4, wherein the first language-second language translator comprises:
a first language-second language translation context information processor configured to receive a first-language sentence input from a first-language user and previous n conversation sentences from a second-language user stored by the conversation context manager, and generate information indicating whether a translation word into which the first-language original is likely to be translated appears in second-language conversation context, the second-language conversation context including the previous n conversation sentences from the second-language user; and
a first language-second language automatic translator configured to generate a second-language translation of the first-language original by the neural network or statistics-based method learned by the first language-second language automatic translation knowledge learning unit, based on the first-language original and the second-language translation word information according to the context of the conversation which are aligned by the first language-second language translation context information processor and the first language-second language automatic translation learning knowledge learned by the first language-second language automatic translation knowledge learning unit.

7. The conversation contextual learning-based automatic translation device of claim 4, wherein the second language-first language translator comprises:
a second language-first language translation context information processor configured to receive a second-language sentence input from a second-language user and previous n conversation sentences from a first-language user stored by the conversation context manager, and generate information indicating whether a translation word into which the second-language original is likely to be translated appears in first-language conversation context, the first-language conversation context including the previous n conversation sentences from the first-language user; and
a second language-first language automatic translator configured to generate a first-language translation of the second-language original by the neural network or statistics-based method learned by the second language-first language automatic translation knowledge learning unit, based on the second-language original and the first-language translation word information according to the context of the conversation which are aligned by the second language-first language translation context information processor and the second language-first language automatic translation learning knowledge learned by the second language-first language automatic translation knowledge learning unit.

8. The conversation contextual learning-based automatic translation device of claim 1, wherein the bidirectional conversation translation set collection unit comprises:
a bidirectional conversation translation collector configured to receive a conversation, which includes an original of a conversation between a first-language user terminal and a second-language user terminal and a first language-second language conversation which is a translation of the original into a counterpart language, and build a first language-second language bidirectional conversation translation sentence set in which a range of the context of the conversation is indicated by marking a start and end of a bidirectional conversation including an original and a translation of the original into a counterpart language;
a monolingual document translation converter configured to receive a monolingual document sentence and translation set, which includes a document written in the first language or the second language and sentences of the document translated into a counterpart language, and convert the monolingual document sentence and translation set into a first language-second language bidirectional conversation translation sentence set by representing the context of the conversation of the other party of each language with sentences in the counterpart language matching previous sentences of the document, wherein the sentences in the counterpart language include sentences of an original or a translation; and
a translation sentence converter configured to receive a monolingual sentence and translation set, which includes only a sentence written in the first language or the second language and a translation thereof and thus does not have previous context, and convert the monolingual sentence and translation set into a first language-second language bidirectional conversation translation sentence set by representing the context of each sentence of the conversation of the other party with a sentence translated into a user's language.

9. A conversation contextual learning-based automatic translation method comprising:
collecting, by a bidirectional conversation translation set collection unit, a bidirectional conversation translation set which is in a conversation form;
building, by an automatic translation knowledge learning unit, first language-second language bidirectional conversation translation learning knowledge using a first language-second language bidirectional conversation translation set; and
translating, by a translation unit, a first language, when received from a first-language user terminal, into a second language using the built first language-second language bidirectional conversation translation learning knowledge and second-language conversation context information provided from a conversation context manager.

10. The conversation contextual learning-based automatic translation method of claim 9, wherein the translating of the first language into the second language comprises translating the second language, when received from a second-language user terminal, into the first language using the built first language-second language bidirectional conversation translation learning knowledge and first-language conversation context information provided from the conversation context manager.

11. The conversation contextual learning-based automatic translation method of claim 9, wherein the first language-second language bidirectional conversation translation learning knowledge comprises:
first language-second language automatic translation learning knowledge learned for automatic translation of a first-language original into a second-language translation; and
second language-first language automatic translation learning knowledge learned for automatic translation of a second-language original into a first-language translation.

12. The conversation contextual learning-based automatic translation method of claim 9, wherein the building of the first language-second language bidirectional conversation translation learning knowledge comprises:
training a first language-second language automatic translation learning unit by a neural network or statistics-based method to generate a second-language translation using a first-language original and second-language translation word information according to context of a conversation which are aligned with each other by a learning language context information processor; and
training a second language-first language automatic translation learning unit by the neural network or statistics-based method to generate a first-language translation using a second-language original and first-language translation word information according to the context of the conversation which are aligned with each other by the learning language context information processor.

13. The conversation contextual learning-based automatic translation method of claim 9, wherein the translating of the first language into the second language comprises:
building, by the conversation context manager, context of a conversation by collecting sentences input from a first-language user and a second-language user during the conversation according to an order of the conversation; and
providing, by the conversation context manager, the context of the conversation to a first language-second language translator and a second language-first language translator to support use of previous conversation sentences from a counterpart-language user as context.

14. The conversation contextual learning-based automatic translation method of claim 13, wherein the translating of the first language into the second language comprises:
receiving, by a first language-second language translation context information processor, a first-language sentence input from the first-language user and previous n conversation sentences from the second-language user stored by the conversation context manager, and generating information indicating whether a translation word, into which a first-language original is likely to be translated, appears in second-language conversation context; and
generating, by a first language-second language automatic translator, a second-language translation of the first-language original by a neural network or statistics-based method learned by a first language-second language automatic translation knowledge learning unit, based on the first-language original and second-language translation word information according to the context of the conversation which are aligned by the first language-second language translation context information processor and first language-second language automatic translation learning knowledge learned by the first language-second language automatic translation knowledge learning unit.

15. The conversation contextual learning-based automatic translation method of claim 13, wherein the translating of the first language into the second language comprises:
receiving, by a second language-first language translation context information processor, a second-language sentence input from the second-language user and previous n conversation sentences from the first-language user stored by the conversation context manager, and generating information indicating whether a translation word, into which a second-language original is likely to be translated, appears in first-language conversation context; and
generating, by a second language-first language automatic translator, a first-language translation of the second-language original by a neural network or statistics-based method learned by a second language-first language automatic translation knowledge learning unit, based on the second-language original and first-language translation word information according to the context of the conversation which are aligned by the second language-first language translation context information processor and second language-first language automatic translation learning knowledge learned by the second language-first language automatic translation knowledge learning unit.

16. The conversation contextual learning-based automatic translation method of claim 9, wherein the building of the first language-second language bidirectional conversation translation learning knowledge comprises:
building, by a first language-second language conversation translation learning database (DB) builder, a first language-second language conversation translation learning DB for translation of the first language into the second language; and
performing learning by a neural network or statistics-based method to generate a second-language translation using a first-language original and second-language translation word information according to context of a conversation which are aligned with each other by a first language-second language learning language context information processor.

17. The conversation contextual learning-based automatic translation method of claim 16, wherein, in the building of the first language-second language conversation translation learning DB for translation of the first language into the second language, the first language-second language conversation translation learning DB comprises triple data including the first-language original, the second-language translation, and second-language conversation context.

18. The conversation contextual learning-based automatic translation method of claim 17, wherein the second-language conversation context comprises second-language original sentences preceding the first-language original and extracted according to the context of the conversation from among the first language-second language bidirectional conversation translation set.

19. The conversation contextual learning-based automatic translation method of claim 9, wherein the bidirectional conversation translation set comprises a set of conversations including a conversation in the first language and the second language and a translation of the conversation into a counterpart language.
